(19) United States
(12) Patent Application Publication
(10) Pub. No.: US 2018/0156663 A1
(43) Pub. Date: Jun. 7, 2018

(54) Identifying Home Décor Items and Paint Colors Based on Colors in an Image

(71) Applicant: PPG Industries Ohio, Inc., Cleveland, OH (US)

(72) Inventors: Kevan M. Farley, Monroeville, PA (US); Phillip J. Behrens, McDonald, PA (US)

(21) Appl. No.: 15/575,431

(22) PCT Filed: May 19, 2016
(86) PCT No.: PCT/US2016/033260

§ 371 Date: Nov. 20, 2017

Related U.S. Application Data
(60) Provisional application No. 62/165,801, filed on May 22, 2015.

(51) Int. Cl. G01J 3/46; G01J 3/02; G06T 7/90

(52) U.S. Cl. CPC G01J 3/462; G01J 3/463; G01J 3/0272; G06T 7/90; G01J 3/0264

(57) ABSTRACT

In one scenario, a computer system wirelessly receives an image from a mobile device. The computer system identifies an available paint color closest to the color of the received image, and further identifies available paint colors that color coordinate with the paint color determined to correspond to the image. The computer system then displays to the user the paint color determined to correspond to the received image and the color coordinated paint colors, receives user input selecting the displayed colors, determines a tint formula corresponding to the selected color and produces a paint code corresponding to the selected color based on the tint formula.

### BACKGROUND

Many homeowners upgrade the look of their homes by doing home projects. In a majority of these projects the homeowner paints one or more rooms. In particular, the walls, ceiling, doors, etc. can be earmarked for a new coat of paint. The homeowner may have an idea of the colors to use, but must determine exact colors before he can buy paint to do the job.

Traditionally, the homeowner has had to travel to the paint store to obtain one or more paint chips, take those paint chips home to compare with existing paint colors and/or colors of home decor items within the home, and then decide on which paint color to use. Many times the homeowner will decide that none of the paint chip colors are acceptable. In that case, the homeowner must obtain different paint chips from the paint store to begin the process anew. This process is very inefficient.

Often the homeowner wants to use a color that is not found on any of the paint chips available from the paint store. For example, the desired color might be a color on a home decor item such as a piece of artwork or a set of drapes. Conventionally, the homeowner can have a store representative customize a paint color based on a paint chip that appears to be the same color as the color in the home decor item. Although the store representative might be experienced in doing this, it still can require some guessing on his or her part. Thus, while this might lead to a paint having the desired color, it can just as often produce a color that is similar to but not the same as the color in the home decor item.

Furthermore, in order to identify a specific color in a home decor item, the user typically has to bring the item to the store to show to the store representative. In some cases, the home decor item that is to be paint-matched is large or heavy, or may even be affixed to the home (such as in cases where the user wants to find paint to match their flooring). The user may be able to take a picture of the home decor item, and show it to the store representative, but the colors may be difficult to discern in a small image, and the store representative would have to go through the same guesswork described above, trying to match the color to a paint chip and then recreating that paint chip as best as possible. This process is highly inefficient and may be fraught with error.

### BRIEF SUMMARY

The present invention described herein is directed to transferring color information associated with a home project to a kiosk at a point of sale location corresponding to a retail establishment and producing paint having a desired color based thereon and to transferring color information associated with a home project to a kiosk at a point of sale location corresponding to a retail establishment and determining home decor items that color coordinate therewith.

In one example, a computer system wirelessly receives an image from a mobile device. The computer system identifies an available paint color closest to at least one of the colors in the received image, and further identifies available paint colors that color coordinate with the paint color determined to correspond to the image. The computer system then displays to the user the paint color determined to correspond to the received image and the color coordinated paint colors, receives user input selecting the displayed colors, determines a tint formula corresponding to the selected color and produces a paint code corresponding to the selected color based on the tint formula.

In another example, a computer system is provided for transferring color information associated with a home project to a kiosk at a point of sale location corresponding to a retail establishment and producing paint having a desired color based thereon. The system includes a computerized device for positioning at a kiosk at a point of sale location corresponding to a retail establishment, where the computerized device includes a display and an input device.

The computerized device is adapted to wirelessly receive an image associated with a home project of a user, determine an available paint color closest to the paint color corresponding to the received image, determine available paint colors that color coordinate with the paint color corresponding to the image, display on the display the paint color corresponding to the received image and the coordinated paint colors, receive user input selecting one of the displayed colors, and determine a tint formula corresponding to the selected color.

The system further includes a paint tinter and/or a paint mixer in electronic communication with the computerized device. The paint tinter/mixer is adapted to electronically receive the tint formula from the computerized device and produce a paint code having the desired color based on the received tint formula.

In another example, a computer system performs a method for transferring color information associated with a home project to a kiosk at a point of sale location corresponding to a retail establishment and determining home decor items that color coordinate therewith. The computer system wirelessly receives an image at the kiosk, where the image is associated with a home project of a user.

The computer system further identifies an available paint color closest to the color of the received image and further determines available home decor items having colors that coordinate with the paint color corresponding to the image. The computer system also displays to the user the paint color corresponding to the received image and images of the home decor items having color coordinated paint colors, receives user input selecting one or more of the displayed home decor items, and informs the user which of the selected home decor items are available at the retail establishment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of present invention may be realized and obtained by means of the instruments and combinations particularly pointed out in the appended claims. Features of the present invention will become more fully apparent from the following description and appended claims.

### BRIEF DESCRIPTION OF THE DRAWINGS

To further clarify the above and other features of the present invention, a more particular description will be rendered by reference to the appended drawings. It is appreciated that these drawings depict only examples of the present invention and are therefore not to be considered limiting of its scope. The present invention will be described and explained with additional specificity and detail through the use of the accompanying drawings in which:

FIG. 1 illustrates a computer architecture in which present invention may operate including transferring color information associated with a home project to a kiosk at a point of sale location corresponding to a retail establishment and producing paint having a desired color based thereon.

FIG. 2 illustrates a flowchart of an example method for transferring color information associated with a home project to a kiosk at a point of sale location corresponding to a retail establishment and producing paint having a desired color based thereon.

FIG. 3 illustrates a flowchart of an example method for transferring color information associated with a home project to a kiosk at a point of sale location corresponding to a retail establishment and determining home decor items that color coordinate therewith.

FIG. 4 illustrates a computer architecture in which present invention may operate including determining products for a home project through a kiosk at a point of sale location corresponding to a retail establishment.

FIG. 5 illustrates an example retail establishment layout including paint area and kiosk.

FIG. 6 illustrates an example kiosk that includes a display and user input devices.

### DETAILED DESCRIPTION

Present invention are directed to transferring color information associated with a home project to a kiosk at a point of sale location corresponding to a retail establishment and producing paint having a desired color based thereon and to transferring color information associated with a home project to a kiosk at a point of sale location corresponding to a retail establishment and determining home decor items that color coordinate therewith.

In one case, a computer system wirelessly receives an image from a mobile device. The computer system identifies an available paint color closest to at least one of the colors in the received image. In some cases, the computer system receives input from the user indicating which color from the image is to be matched. The computer system further identifies available paint colors that color coordinate with the paint color determined to correspond to the image. The computer system then displays to the user the paint color determined to correspond to the received image and the color coordinated paint colors, receives user input selecting the displayed colors, determines a tint formula corresponding to the selected color and produces a paint code corresponding to the selected color based on the tint formula.

In another case, a computer system is provided for transferring color information associated with a home project to a kiosk at a point of sale location corresponding to a retail establishment and producing paint having a desired color based thereon. The system includes a computerized device for positioning at a kiosk at a point of sale location corresponding to a retail establishment, where the computerized device includes a display and an input device.

The computerized device is adapted to wirelessly receive an image associated with a home project of a user, determine an available paint color closest to the paint color corresponding to the received image, determine available paint colors that color coordinate with the paint color corresponding to the image, display on the display the paint color corresponding to the received image and the coordinated paint colors, receive user input selecting one of the displayed colors, and determine a tint formula corresponding to the selected color.

The system further includes a paint mixer in electronic communication with the computerized device. The term “paint mixer” may refer to a paint tinter, a paint aggitator/mixer or both combined together. The paint mixer is adapted to electronically receive the tint formula from the computerized device and produce a paint code having the desired color based on the received tint formula. In some cases, a user may select a paint color and/or one or more home decor items online. The user may then be able to print out a unique barcode or quick response (QR) code. The can then take that printed barcode or QR code to the kiosk at the store where their project could be accessed (using the code) for further editing. Additionally or alternatively, the kiosk may access the user's project, identify the associated products, and point the user to those products or to a store assistant who could help the user find the products.

In another case, a computer system performs a method for transferring color information associated with a home project to a kiosk at a point of sale location corresponding to a retail establishment and determining home decor items that color coordinate therewith. The computer system wirelessly receives an image at the kiosk, where the image is associated with a home project of a user.

The computer system further identifies an available paint color closest to the color of the received image and further determines available home decor items having colors that coordinate with the paint color corresponding to the image. The computer system also displays to the user the paint color corresponding to the received image and images of the home decor items having color coordinated paint colors, receives user input selecting one or more of the displayed home decor items, and informs the user which of the selected home decor items are available at the retail establishment.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Present invention may implement various types of computing systems, and may use these computing systems to perform computerized methods. These computing systems are now increasingly taking a wide variety of forms. Computing systems may, for example, be handheld devices such as smartphones or feature phones, appliances, laptop computers, tablets, wearable devices, desktop computers, mainframes, distributed computing systems, or even devices that have not conventionally been considered a computing system.

In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

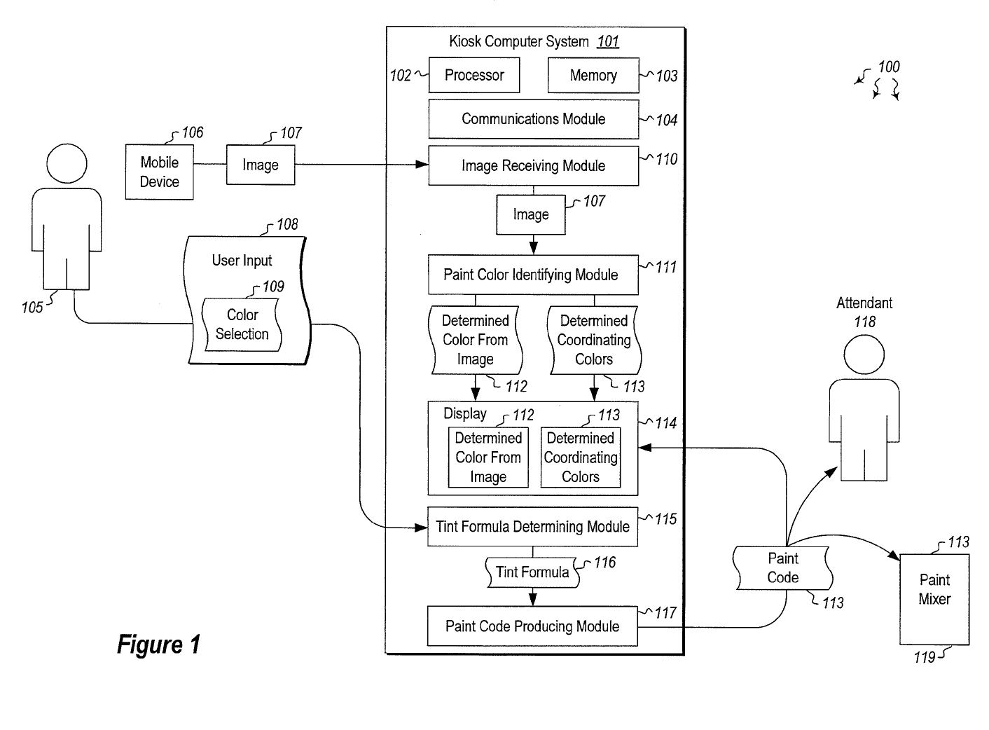

As illustrated in FIG. 1, a kiosk computing system 101 may include at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, the present invention is described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product.

An example of such an operation involves the manipulation of data. The computer-executable instructions (and the manipulated data) may be stored in the memory 103 of the computing system 101. Kiosk computing system 101 may also contain communication channels that allow the computing system 101 to communicate with other message processors over a wired or wireless network. Such communication channels may include hardware-based receivers, transmitters or transceivers, which are configured to receive data, transmit data or perform both.

Present invention may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

Present invention also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, present invention may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the present invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The present invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which the present invention may be employed. Computer architecture 100 includes kiosk computer system 101 (or simply “kiosk 101” herein). Kiosk computer system 101 may be any type of local or distributed computer system, including a cloud computing system. The kiosk computer system 101 includes modules for performing a variety of different functions.

For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems. The communications module 104 may also be able to communicate locally with a personal electronic device (e.g. using a wireless hub built within the kiosk). Or, the communications module 104 can communicate with the cloud, and the cloud may communicate wirelessly with the personal electronic device.

The kiosk computer system 101 may use its communications module 104 to communicate with mobile device 106 belonging to user 105. The mobile device 106 may be any type of mobile digital device including a smartphone, laptop, tablet, wearable device or other type of mobile computing system. The communications module 104 may also be configured to communicate with non-mobile, embedded or other types of computing systems. The communications may be over Bluetooth, Wifi, or other wireless data transfer means.

The kiosk computer system 101 may further include an image receiving module 110. The image receiving module 110 may receive image 107 from user 105. The image 107 may include any type of digital image or video. The image 107 may include a single, solid color, or may include many different colors. The image may include people, landscapes, home decor items or any other subject matter. In some cases, the image 107 will have one or more colors which the user 105 desires to implement in a home project.

A home or business project may include remodeling, repainting, redecorating, adding or removing spaces or even building a new home or office. “Project information” is any type of data related to a specified home or business project. The project information may thus include materials, timelines, home decor objects including artwork or furniture, budget information or any other information related to a work that is to be performed on a house, office or other spaces including outdoor spaces. In some cases, this project information may include paint color, and that paint color may be based on image 107.

In some of the present invention, the project information will be related to remodeling or repainting projects where a user (e.g. 105) is repainting one or more rooms and is using the kiosk computer system 101 to determine a paint color to use on a home project. The user may use the kiosk to customize a paint color, color coordinate a paint color with other home decor items, or find home decor items that match a certain paint color. The customized paint color may be drawn from a palette of existing colors, or may be separately derived. As such, the customized paint color may be a color that is not part of an existing palette of colors. The color may be named by the user and stored in the user's profile for later use.

The kiosk computer system 101 may thus receive an image 107 and identify colors from the image and determine which colors coordinate with that image. The kiosk computer system 101 may also receive user input 108 that includes a color selection 109. The paint color identifying module 111 may determine a primary color 112 from the image 107 (or a plurality of colors), and may further determine one or more coordinating colors 113 that coordinate with the determined primary color(s). These primary colors 112 and coordinating colors 113 may be displayed on kiosk display 114. The user may select from these displayed colors and thereby indicate which colors they want to use to create customized paint for their home project. Once the colors are selected, the user may upload an image of their project orof a given room, and can paint the project (i.e. paint the image of their room) with the colors selected. In this manner, the user will be able to see what their room or project would look like when painted in their chosen color.

The color selection 109 input may be provided to the tint formula determining module 115. The tint formula determining module 115 may generate a tint formula 116 that can be applied to a base paint to create the user customized color representation. The tint formula may provide a specified amount of coloring that is to be applied to the base paint to color it according to the determined image color 112 or the determined coordinating color 113.

In some cases, the tint formula 116 devised by the tint formula determining module 115 may be specific to a certain brand of base paint or to a certain family of brands or to certain types of paints. Each paint manufacturer may have their own unique and proprietary formula for creating a base paint. As such, when tints are applied to different manufacturers' base paints, the tints may produce slightly different colors. Thus, when the tint formula determining module 115 determines a tint formula to create a desired color, the tint formula is a unique formula that only works with a specific manufacturer's base paint formula. As such, the manufacturer of the kiosk 101 may partner with a paint manufacturer to create and sell customized paints using its base paint. Alternatively, the paint manufacturer itself may produce the kiosk 101, which generates tint formulas that work specifically with its brand of base paint.

The tint formula 116 may be provided to the paint code producing module 117, which itself generates a paint code 113 that represents the user-selected image color or coordinating color and a tint formula 116 that can be used to create a color of paint indicated by a wirelessly-transferred image. This paint code 113 may be sent to the kiosk display 114 for display to the user 105, may be sent to an attendant in a retail establishment's paint area so that the attendant 118 can mix the paint using the code, or may be sent to a paint mixer 119 directly for production of the paint. In other cases, the paint code may be printed on paper as a bar code or a QR code, and then given to a paint station attendant for assistance in making the customized paint.

The paint code 113 may be any type of name, number or other identifier that precisely indicates which color of paint to create. In some cases, the attendant 118 may mix the paint manually or initiate a mixer to mix the paint, or the paint code may be sent directly to an automated mixer 119 that combines the colors indicated by the tint formula with the base paint to generate the color provided by the user's image 107.

Thus, in this manner, a user 105 may wirelessly transfer an image of a home decor item, an article of clothing, a carpet or flooring sample, a kitchen fixture or appliance, a painting, an heirloom, a piece of furniture or any other object with which they wish to match a paint color. The user may provide this image 107 to the kiosk 101, where the kiosk will identify the color(s) in the image and further determine coordinating colors that would go with that color.

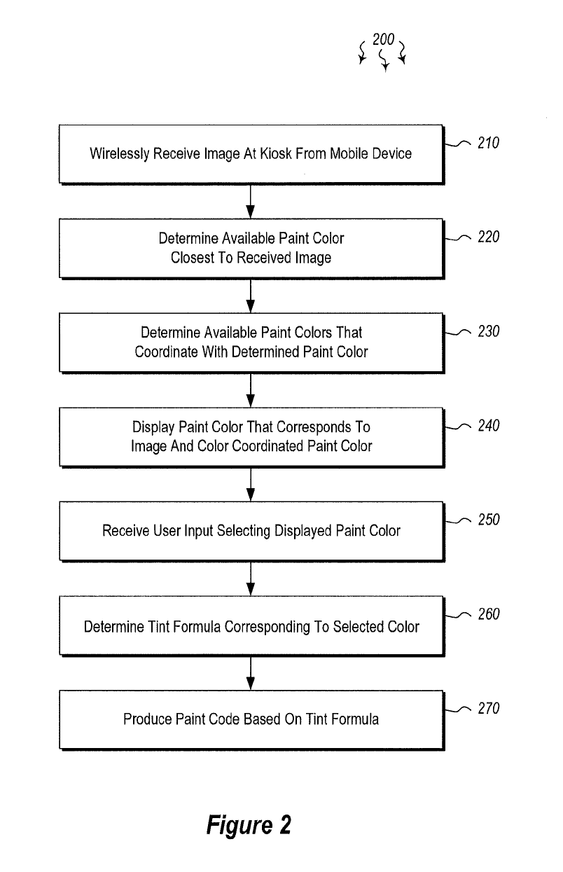

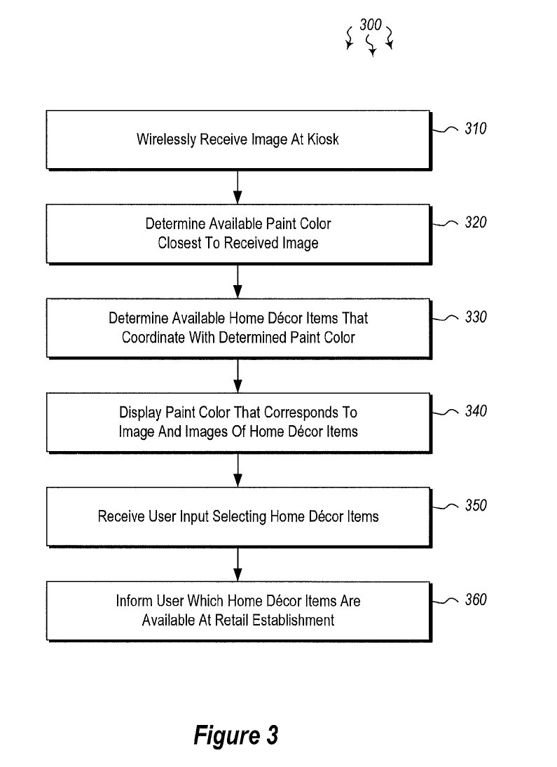

Then, once the user has selected the color or colors they like, they may have virtually any quantity of paint produced in those colors. Moreover, the paint code 113 that was generated during this process may be stored in the user's kiosk profile so that if the user wants to produce more paint of those colors at some future point in time, the kiosk 101 will simply be able to provide the code to the attendant 118 or paint mixer 119. In some cases, a user may upload a picture to their profile and then retrieve the picture at an in-store kiosk. The user may provide this picture as the source for which colors to match. The user may select one or more colors in the picture, and the kiosk will identify colors that match the selected color(s). These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for transferring color information associated with a home project to a kiosk at a point of sale location corresponding to a retail establishment and producing paint having a desired color based thereon. The method 200 will now be described with frequent reference to the components and data of environment 100.

Method 200 includes wirelessly receiving an image at the kiosk from a mobile device (210). For example, the image receiving module 110 of kiosk computer system 101 may receive image 107 via a wireless connection such as Bluetooth, WiFi, radio frequency (RF) or near field communication (NFC). The image may be received from a mobile device 106 that is on-premises, near the kiosk, or may be received from a mobile device that is remote from the kiosk 101. In some cases, the image 107 may be wirelessly received from a cloud data store or from some other data source such as a thumb drive or optical disc. The image 107 includes a plurality of colors that are to be identified and color coordinated by the kiosk.

In line with this, method 200 next includes identifying, by the kiosk, an available paint color closest to the color of the received image (220). In some cases, the computer system 101 may receive input from a kiosk user indicating which color from the image is to be matched. The kiosk computer system 101 may also identify one or more available paint colors that color coordinate with the paint color determined to correspond to the image (230). The paint color identifying module 111 may identify, based on an analysis of the received image 107, one or more colors 112 that are present in the image, and may further determine a paint color that is closest to that color.

The analysis may look at the entire image as a whole, or may analyze portions of the image separately. In some cases, the user 105 may indicate to the kiosk which color or colors are to be used. For instance, the user may use a mouse cursor or touchscreen to select the portion of the image that contains the desired color(s). The paint color identifying module 111 may also determine available paint colors 113 that coordinate with the identified colors 112. In some cases, the available paint colors may be specific to a certain paint manufacturer. In these situations, the tint formula determining module 115 may generate a tint formula that will apply a set of dyes or pigments that, when combined with the based paint of that manufacturer, will create a paint with the desired paint color.

Method 200 further includes displaying to the user, by the kiosk, the paint color determined to correspond to the received image and the one or more color coordinated paint colors (240), receiving, by the kiosk, user input selecting one or more of the displayed colors (250), determining, by the kiosk, a tint formula corresponding to the selected color (260), and producing a paint code corresponding to the selected color based on the tint formula (270). The determined color 112 from the image 107 and the determined coordinating colors 113 may be displayed in kiosk display 114. The user 105 may then provide input 108 that includes a color selection input 109. The color selection input may select from those paint colors that are determined to be available or would be mixable using a custom tint formula 116.

The tint formula determining module 115 may then generate a tint formula 116 that lists amounts of pigments or dyes that are to be added to a base paint to generate the user-selected color taken from the wirelessly transferred image 107. The paint code producing module 117 may then produce paint code 113 which includes the tint formula 116 or at least an identifier for the tint formula. This paint code 113 may then be used to generate the paint. The paint may be mixed by an attendant 118, or may be tinted and mixed automatically by a paint mixer 119. In some cases, the computerized parts of the kiosk and the paint mixer itself may be part of and positioned within the kiosk 101.

The kiosk computer system 101 may be further configured to associate a unique ID with the image, and perform the steps of the method 200 only after the unique ID is received from the user. The unique ID associated with the image may be attached to the user's profile, which itself may have a unique identifier. Thus, when the user logs in to the kiosk, their profile is accessed, and any unique IDs for images in their profile may also be accessible. The user may thus use any images they have uploaded to the kiosk at future points in time. In this manner, the received image 107 may be associated with the user 105 for future paint production. Moreover, any paint colors selected in conjunction with the image 107 may also be saved in the user's profile.

A local or distributed database may be accessible to the kiosk computer system 101. The database may store the user's profile, including any uploaded images, color selections or color associations. Indeed, the colors determined from the image 112, and the coordinating colors 113 may be stored in the user's profile, along with an indication of which colors were ultimately selected and made into paint. In such cases, the tint formulas 116 and/or paint codes 117 may also be stored in the user's profile.

The database may keep track of these image colors and corresponding paint colors, and may keep track of the associations made between image colors and paint colors. The database may also store an indication of paint colors that go along with any selected paint colors. In this manner, the database may continually build and refine associations between colors identified in images, and colors that were ultimately made into paint. In addition to associations between images and paint colors, the database may also be configured to store home decor purchases and associated home decor colors in the user profile. Thus, in this manner, a database may store images, paint colors, home decor items, projects and home decor colors, among other information, in the user's profile.

In some cases, the paint may be specific to a single manufacturer, or may be specific to a certain type of paint (e.g. water-based paint or solvent-based paint). The kiosk computer system 101 may also be configured to associate colors available from one paint manufacturer with other paint colors of the paint manufacturer that color coordinate with the paint color determined to correspond to the received image. Thus, the kiosk may allow users to provide images and match paint colors to those images. The kiosk may also provide paint colors that color coordinate with a selected paint color. In this manner, a kiosk user may be able to provide an image of a home decor item they wish to design a room around, and may be able to easily find paint that matches and color coordinates with that home decor item.

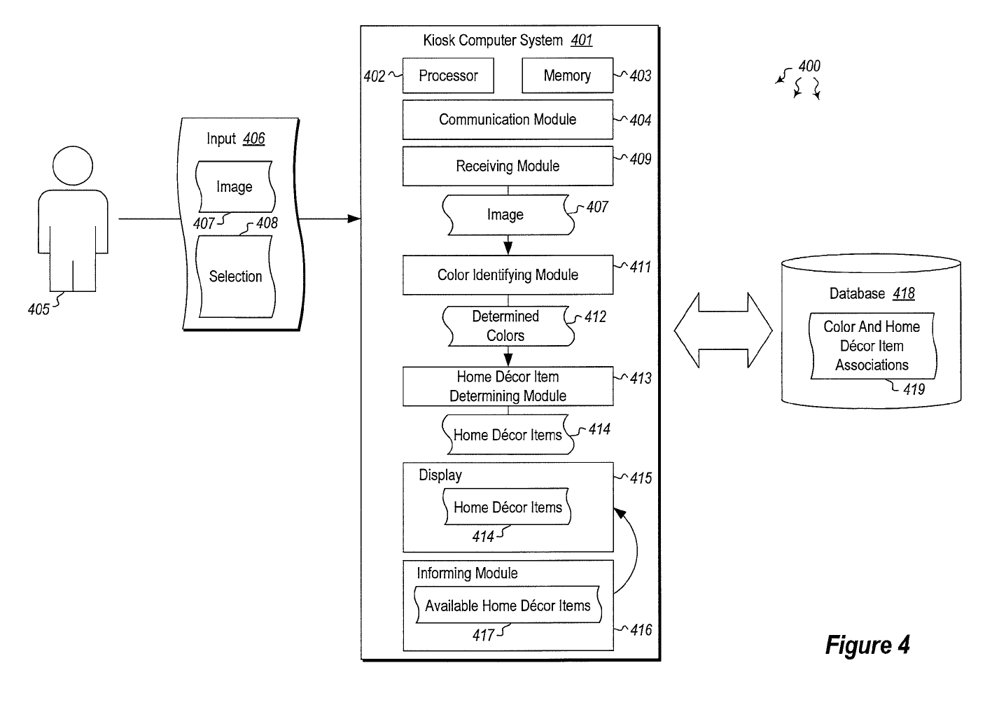

FIG. 3 illustrates a flowchart of a method 300 for transferring color information associated with a home project to a kiosk at a point of sale location corresponding to a retail establishment and determining home decor items that color coordinate therewith. The method 300 may be performed on a kiosk computer system 401 similar to or the same as kiosk computer system 101 of FIG. 2. The kiosk computer system 401 may include a processor 402, memory 403 and a communication module 404 which is configured to communicate via other computing system via wired or wireless communication means. The method 300 will now be described with frequent reference to the components and data of environment 400 of FIG. 4.

Method 300 includes wirelessly receiving an image at the kiosk, the image being associated with a home project of a user (310). For example, the receiving module 409 may receive image 407 in input 406 from the user 405. The image may be any type of digital image or video, and may only be a portion of an image or video. The image 407 may have many different colors, or may only have a single color. The image 407 may be transferred wirelessly using a mobile device (e.g. via Bluetooth, WiFi or NFC), or may be transferred using physical storage media such as a thumb drive or optical disc.

Method 300 next includes identifying, by the kiosk, an available paint color closest to the color of the received image (320), and determining, by the kiosk, one or more available home decor items having colors that coordinate with the paint color corresponding to the image (330). The color identifying module 411 of the kiosk computing system 401 may thus determine available paint colors 412 that are closest to the color of the received image 407, and may also identify coordinating colors that coordinate with the paint color of the image.

In cases where the image includes multiple colors, the user 405 may select a color (e.g. using selection input 408) from the image by pointing to it with a finger (e.g. on a touchscreen) or by selecting it with a mouse cursor. In some cases, the color identifying module may use not only the selected color, but the other colors from the image in identifying coordinating colors, so that the coordinating colors match the other (non-selected) image colors as well.

Once the primary colors 412 and coordinating colors have been identified, the home decor item determining module 413 may identify which home decor items 414 match or color coordinate with the color(s) indicated by the image 407. The identified home decor items 414 may include those products that are in stock and available for purchase at the store, or may include items that are available for purchase in neighboring stores or online.

Method 300 further includes displaying to the user, by the kiosk, the paint color corresponding to the received image and images of the one or more home decor items having color coordinated paint colors (340), receiving, by the kiosk, user input selecting one or more of the displayed home decor items (350), and informing the user, by the kiosk, which of the selected home decor items are available at the retail establishment (360).

The home decor items 414 identified by the home decor item determining module 413 may be displayed in kiosk display 415. When displayed, the user 405 may view the items 414 and select which ones they are interested in. The selection input 408 may be received by the receiving module 409 and may be passed to the informing module 416. The informing module 416 of the kiosk computer system 401 may be configured to inform the user as to which of the selected items is available at the store.

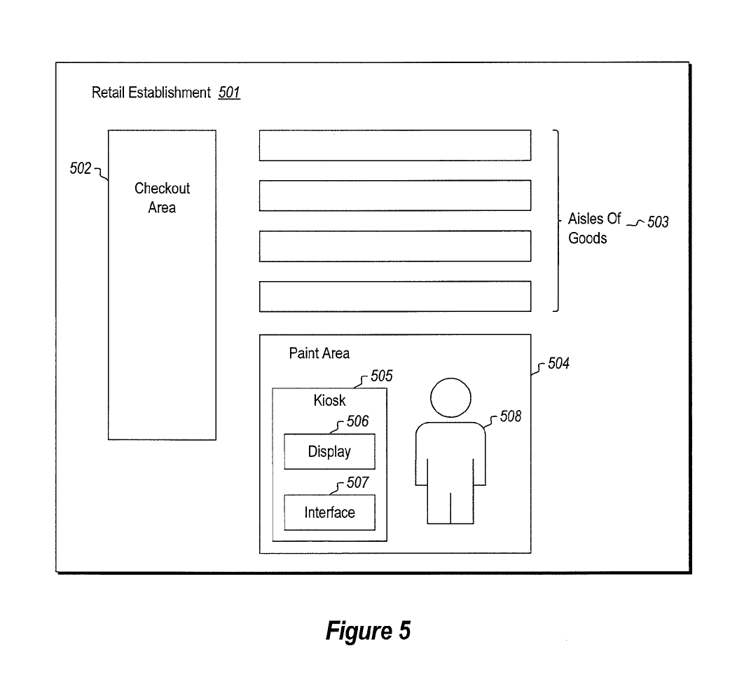

In some cases, informing the user 405 which of the selected home decor items is available at the retail establishment further includes indicating where to locate the available selected home decor items in the retail establishment. As shown in FIG. 5, retail establishment 501 may include multiple different areas including a checkout area 502, various aisles of goods 503 and a paint area 504 (among other areas not shown).

The retail establishment may be a hardware store or home goods store or other type of retail establishment. The paint area 504 may be where the kiosk computer system 505 (e.g. kiosk 101 from FIG. 1) is located. The kiosk may include a display 506 and various user interface means 507 including a keyboard, mouse, touchscreen or other user interface hardware. The user 508 may use the kiosk 505 to perform various functions including identifying home decor items that match a specified home decor item or paint color.

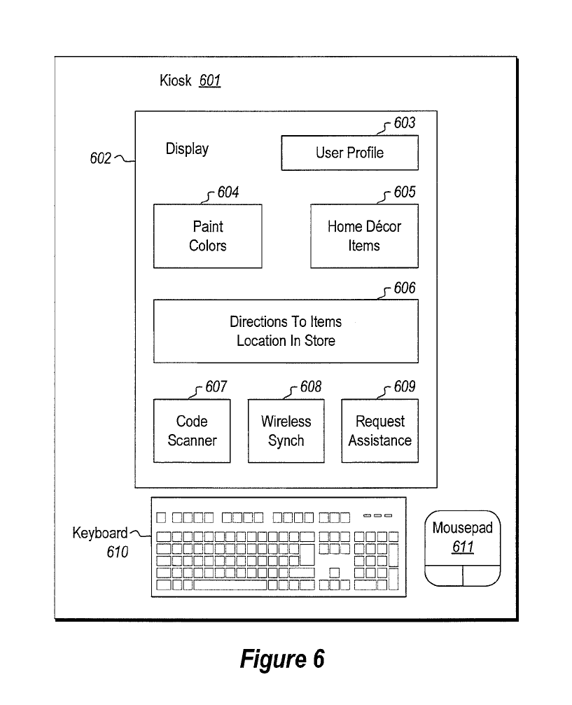

One example of a kiosk is shown in FIG. 6. The kiosk 601 includes a display 602 that displays various project-related items. These items may include, among other things, directions 606 to an item's location within the retail establishment 501. The directions may include an aisle number, a map showing where the specified aisle is located, a video showing directions to the product, or other ways of locating the selected product(s) such as a pin on a digital map.

The kiosk 601 may further display paint colors 604 which may be a color for which color coordinating home decor items are to be found. The kiosk 601 may also display home decor items 605. These may be the home decor items 414 that were identified by the product identifying module as being color coordinated with the identified color and/or coordinating colors 412. The kiosk 601 may also include a code scanner 607 capable of scanning bar codes, quick response (QR) codes or other types of codes.

Using the code scanner, the user may input project information, or may provide indications of products which the user would like to use in their project (e.g. by scanning the product's bar code) and color match to the colors from the wirelessly received image 407. These products may then be color-matched to other products or project materials available for sale at the store or available online.

The kiosk 601 of FIG. 6 may further include a wireless synchronization feature 608 that allows users to upload images or other project information to the kiosk. The user may use a Bluetooth, WiFi or other type of wireless connection, for example, between their mobile device and the kiosk 601 to transfer images or other project information. The user may transfer the images or project information through a local wireless hub, or through the internet or through one or more cloud computing systems. The user may interact with the kiosk using keyboard 610, mouse pad 611 or may interact with the display 602 directly if the display is a touchscreen.

The user input devices may allow the user to change settings, make selections, establish a link to a mobile device, scan codes or perform other tasks including requesting assistance. The kiosk 601 may display a request assistance 609 that, when selected, allows the kiosk user to request that a store personnel be notified of the user's interest in a selected product. The user may also use the user interface hardware to select and/or change their user profile 603.

The user profile 603 may include many different kinds of information about the kiosk user including the user's name, current project, past projects, color preferences or color profiles, product or brand name preferences or other information that may be linked to their profile including project information and uploaded images stored on a cloud data store (e.g. database 118 of FIG. 1). Thus, a user may log in at the kiosk 601 and select the user profile button 603 to access their user profile.

This profile may list items purchased in the past, items in a wish list, items selected for a current project (including paint colors 604 and home decor items 605) or other project information. At least some portions of the project information may be stored in a cloud data store, and may be accessed on demand by the kiosk 601. This project information may be used to identify other products provided by the retail establishment that would match or correspond to a given image, project and/or color profile.

In this manner, the kiosk can identify products that are currently in-stock and available at the retail establishment, or are available to be shipped online. In some cases, the user may be shown directions to the products they have selected on a map, or they may be guided to the location of the products by a store personnel who has been notified of the user's interest in that product, or may notify another entity that the selected products are to be automatically retrieved and given to the user.

Accordingly, methods, systems and computer program products are provided which transfer color information associated with a home project to a kiosk at a point of sale location corresponding to a retail establishment and producing paint having a desired color based thereon. Moreover, methods, systems and computer program products are provided which transfer color information associated with a home project to a kiosk at a point of sale location corresponding to a retail establishment and determine home decor items that color coordinate therewith.

As used in the specification, a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise.

Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Furthermore, as used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the invention or claims.

In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) when referring to a specific instance of the element.

The concepts and features described herein may be embodied in other specific forms without departing from their spirit or descriptive characteristics. The described features are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computerized method of transferring color information associated with a home project to a kiosk at a point of sale location corresponding to a retail establishment and producing paint having at least one desired color based thereon, comprising:
wirelessly receiving an image at the kiosk from a mobile device;
identifying, by the kiosk, at least one available paint color closest to the at least one color of the received image;
identifying, by the kiosk, one or more available paint colors that color coordinate with the paint color determined to correspond to the image;
displaying to the user, by the kiosk, the paint color determined to correspond to the received image and the one or more color coordinated paint colors;
receiving, by the kiosk, user input selecting one or more of the displayed colors;
determining, by the kiosk, a tint formula corresponding to the selected color; and
producing a paint code corresponding to the selected color based on the tint formula.

2. The computerized method of claim 1, wherein the available paint colors are specific to a specified paint manufacturer.

3. The computerized method of claim 1, wherein the color corresponding to the received image is a color corresponding to a portion of the image specified by the user.

4. The computerized method of claim 1, further comprising associating a unique ID with the image and performing the steps of the method only after the unique ID is received from the user.

5. The computerized method of claim 1, further comprising associating one or more paint colors available from a paint manufacturer with one or more other paint colors of the paint manufacturer that color coordinate with the paint color determined to correspond to the received image.

6. The computerized method of claim 1, wherein the image is wirelessly received from a cloud data store.

7. The computerized method of claim 1, further comprising associating the one or more selected colors with the user for future paint production.

8. The computerized method of claim 1, further comprising associating the received image with the user for future paint production.

9. The computerized method of claim 1, wherein the received image includes a plurality of colors that are to be color coordinated by the kiosk.

10. A system for transferring color information associated with a home project to a kiosk at a point of sale location corresponding to a retail establishment and producing paint having a desired color based thereon, comprising:
a computerized device for positioning at a kiosk at a point of sale location corresponding to a retail establishment, the computerized device comprising a display and an input device, the computerized device being adapted to:
wirelessly receive an image associated with a home project of a user;
identify at least one available paint color closest to the paint color corresponding to the received image;
identify one or more available paint colors that color coordinate with the paint color corresponding to the image;
display on the display the paint color corresponding to the received image and the one or more color coordinated paint colors;
receive user input selecting one of the displayed colors;
determine a tint formula corresponding to the selected color; and
a paint mixer in electronic communication with the computerized device, the paint mixer being adapted to:
electronically receive the tint formula from the computerized device; and
produce a paint having the desired color based on the received tint formula.

11. The system of claim 10, wherein the computerized device and the paint mixer are both positioned at the kiosk.

12. The system of claim 10, further comprising a database that associates selected paint colors with corresponding users.

13. The system of claim 10, further comprising a database that associates available paint colors with other available paint colors that coordinate therewith.

14. The system of claim 10, wherein the available paint colors are specific to a specified paint manufacturer.

15. The system of claim 14, wherein the tint formula applies to base paint produced by the specified paint manufacturer.

16. A computerized method for transferring color information associated with a home project to a kiosk at a point of sale location corresponding to a retail establishment and determining home decor items that color coordinate therewith, comprising:
wirelessly receiving an image at the kiosk, the image being associated with a home project of a user;
identifying, by the kiosk, an available paint color closest to the color of the received image;
determining, by the kiosk, one or more available home decor items having colors that coordinate with the paint color corresponding to the image;
displaying to the user, by the kiosk, the paint color corresponding to the received image and images of the one or more home decor items having color coordinated paint colors;
receiving, by the kiosk, user input selecting one or more of the displayed home decor items;
informing the user, by the kiosk, which of the selected home decor items are available at the retail establishment.

17. The computerized method of 16, wherein informing the user, by the kiosk, which of the selected home decor items are available at the retail establishment further comprises the kiosk indicating where to locate the available selected home decor items in the retail establishment or where the selected home decor items are available online.

18. The computerized method of claim 16, wherein informing the user, by the kiosk, which of the selected home decor items are available at the retail establishment further comprises displaying a map and directions to the specific aisle in the retail establishment that has the selected home decor items.

19. The computerized method of claim 16, further comprising communicating, by the kiosk, to a retail establishment personnel to indicate that the kiosk user is interested in locating the selected home decor items.

20. The computerized method of claim 16, wherein a display of the kiosk provides a means of identifying a retail establishment personnel for assistance in finding the selected home decor items.
